(19) United States
(12) Patent Application Publication
(10) Pub. No.: US 2018/0178594 A1
(43) Pub. Date: Jun. 28, 2018

(54) PNEUMATIC TIRE

(71) Applicant: TOYO TIRE & RUBBER CO., LTD., Itami-shi (JP)

(72) Inventor: Hiraku Nagayoshi, Itami-shi (JP)

(73) Assignee: TOYO TIRE & RUBBER CO., LTD., Itami-shi (JP)

(21) Appl. No.: 15/786,779

(22) Filed: Oct. 18, 2017

(30) Foreign Application Priority Data
Dec. 27, 2016 (JP) 2016-252664

(51) Int. Cl. B60C 19/08; B60C 11/00

(52) U.S. Cl. CPC B60C 19/082; B60C 2011/0033; B60C 11/005

(57) ABSTRACT

A tire has a cap rubber, a base rubber, and a conductive rubber. The cap rubber which is formed by a nonconductive rubber and constructs a ground surface. The base rubber which is provided in an inner side in a tire radial direction of the cap rubber. The conductive rubber which extends in a thickness direction of the cap rubber, passes an inner portion of the cap rubber and gets to a bottom surface of the base rubber from the ground surface. An interface end which is in contact with the conductive rubber in an interface between the cap rubber and the base rubber comes down to an inner side in a radial direction in comparison with an interface in a periphery of the interface end.

### BACKGROUND OF THE INVENTION

### Field of the Invention

The present disclosure relates to a pneumatic tire which can discharge static electricity generated in a vehicle body or a tire to a road surface.

### Description of the Related Art

In recent years, for the purpose of reducing a rolling resistance of a tire which has strong relationship to a fuel consumption performance, there has been proposed a pneumatic tire in which a rubber member such as a tread rubber is formed by a non-conductive rubber blended with silica at a high rate. However, since an electric resistance is higher in the rubber member in comparison with a conventional product which is formed by a conductive rubber blended with carbon black at a high rate, and inhibits static electricity generated in a vehicle body or the tire from being discharged to a road surface, the rubber member has a problem that a problem such as a radio noise tends to be generated. Consequently, it is necessary to appropriately secure a conductive route for discharging the static electricity.

JP5344098 discloses a tire in which a conductive rubber extending in a radial direction is arranged in a tire equator. In this tire, as shown in FIG. 5, a conductive rubber 52 passes through a cap rubber 50 and a base rubber 51, and the base rubber 51 in a portion which is in contact with the conductive rubber 52 extends so as to climb up to a radially outer side RD1.

### SUMMARY OF THE INVENTION

However, in the structure in which an end of the base rubber 51 extends so as to climb up to the radially outer side RD1 such as JP5344098, a rigidity difference is generated in the end portion of the base rubber, and there is fear that a crack is generated due to concentration of strains, so that durability is lowered.

The present disclosure is made by paying attention to the circumstances as mentioned above, and an object of the present disclosure is to provide a pneumatic tire in which durability performance is improved in the end stage of wear.

The present disclosure employs the following means for achieving the object.

In other words, according to the present disclosure, there is provided a pneumatic tire including a cap rubber which is formed by a nonconductive rubber and constructs a ground surface, a base rubber which is provided in an inner side in a tire radial direction of the cap rubber, and a conductive rubber which extends in a thickness direction of the cap rubber, passes an inner portion of the cap rubber and gets to a bottom surface of the base rubber from the ground surface. An interface end which is in contact with the conductive rubber in an interface between the cap rubber and the base rubber comes down to an inner side in a radial direction in comparison with an interface in a periphery of the interface end.

According to the structure, since the interface end of the base rubber comes down to the inner side in the radial direction, it is possible to avoid the strain concentration and it is possible to improve the durability.

### BRIEF DESCRIPTION OF THE DRAWINGS

FIG. 1 is a tire meridian cross sectional view showing an example of a pneumatic tire according to the present disclosure;

FIG. 2 is a cross sectional view showing a structure of a conductive rubber according to Example 1 and a periphery thereof;

FIG. 3 is a cross sectional view showing a structure of a conductive rubber according to Example 2 and a periphery thereof;

FIG. 4 is a cross sectional view showing a structure of a conductive rubber according to Comparative Example 1 and a periphery thereof; and

FIG. 5 is a cross sectional view showing a structure of a conductive rubber according to Comparative Example 2 and a periphery thereof.

### DETAILED DESCRIPTION OF THE PREFERRED EMBODIMENTS

A description will be given below of a pneumatic tire according to an embodiment of the present disclosure with reference to the accompanying drawings.

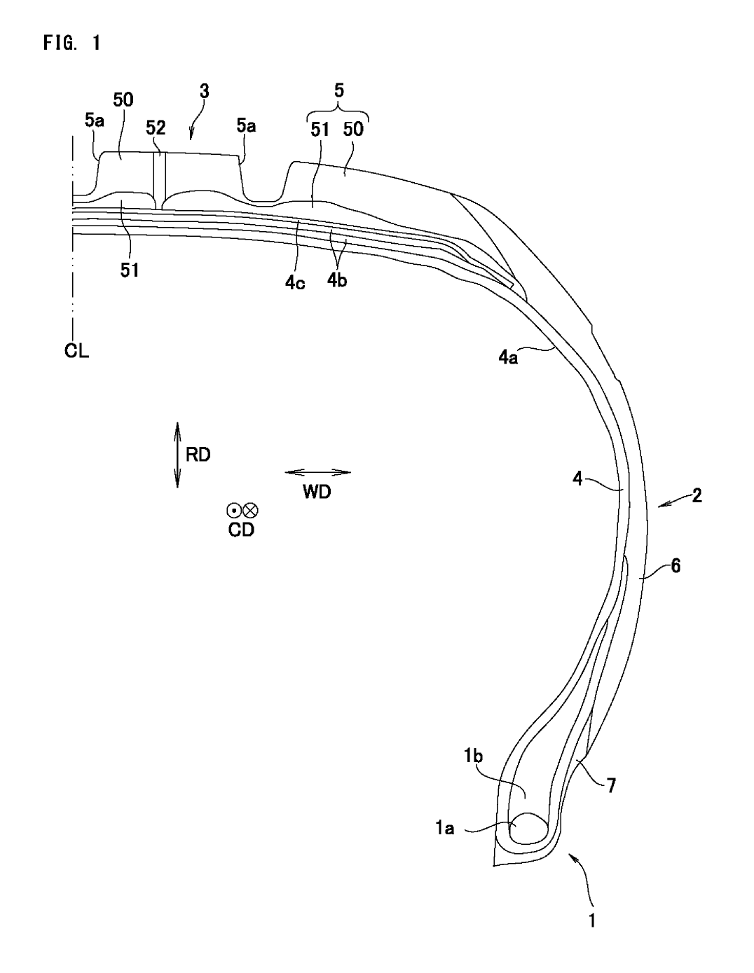

As shown in FIG. 1, a pneumatic tire T is provided with a pair of bead portions 1, side wall portions 2 which extend to outer sides in a tire radial direction RD from the respective bead portions 1, and a tread portion 3 which is connected to outside ends in the tire radial direction RD from both the side wall portions 2. An annular bead core 1a and a bead filler 1b are arranged in the bead portion 1, the annular bead core 1a covering a convergence body such as a steel wire by a rubber, and the bead filler 1b being made of a hard rubber.

Further, the tire T is provided with a toroidal carcass layer 4 which runs into the bead portions 1 from the tread portion 3 via the side wall portions 2. The carcass layer 4 is provided between a pair of bead portions 1, is constructed by at least one carcass ply, and is locked in a state in which its end portions are rolled up via the bead cores 1a. The carcass ply is formed by coating with a topping rubber a cord which extends approximately vertically to a tire equator CL. An inner liner rubber 4a for retaining a pneumatic pressure is arranged in an inner side of the carcass layer 4.

Further, a side wall rubber 6 is provided in an outer side of the carcass layer 4 in the side wall portion 2. Further, a rim strip rubber 7 is provided in an outer side of the carcass layer 4 in the bead portion 1, the rim strip rubber 7 coming into contact with a rim (not shown) when being installed to the rim. In the present embodiment, the topping rubber of the carcass layer 4 and the rim strip rubber 7 are formed of a conductive rubber, and the side wall rubber 6 is formed of a nonconductive rubber.

An outer side of the carcass layer 4 in the tread portion 3 is provided with a belt 4b for reinforcing the carcass layer 4, a bet reinforcing member 4c, and a tread rubber 5 in this order from an inner side toward an outer side. The belt 4b is constructed by a plurality of belt plies. The belt reinforcing member 4b is constructed by coating a cord extending in a tire peripheral direction with a topping rubber. The belt reinforcing member 4b may be omitted as occasion demands.

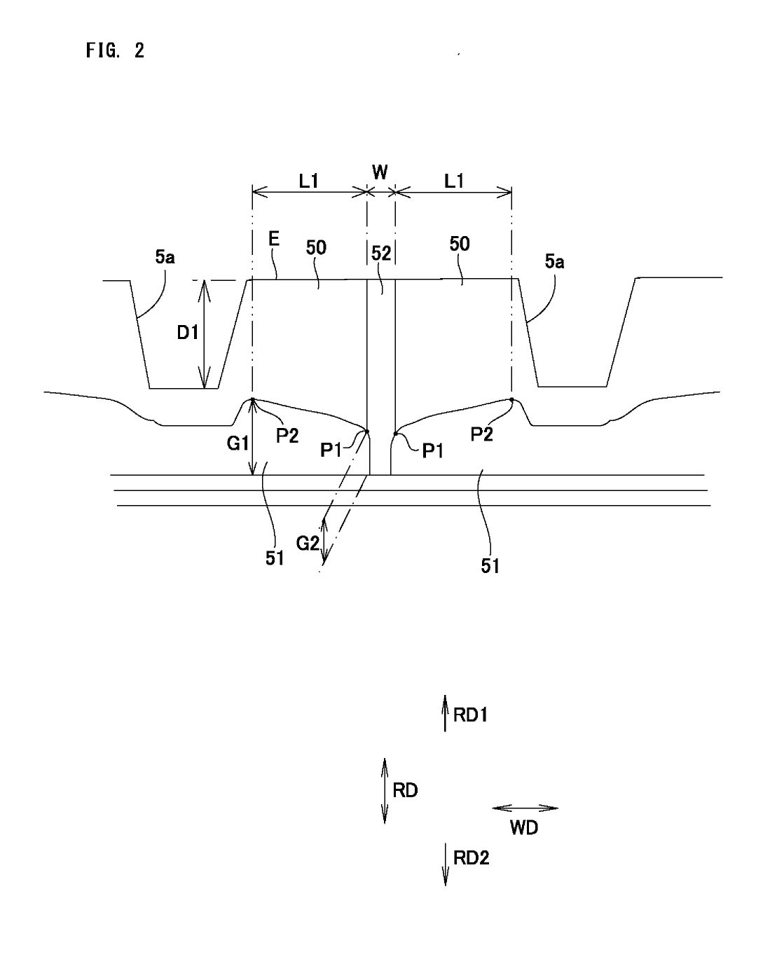

As shown in FIGS. 1 and 2, the tread rubber 5 has a cap rubber 50 which is formed of the nonconductive rubber and constructs a ground surface E, and a base rubber 51 which is provided in an inner side in a tire radial direction of the cap rubber 50. A plurality of main grooves 5a extending along a tire circumferential direction are formed on a surface of the cap rubber 50. In the cap rubber 50, there are formed a main groove 5a which extends in a tire peripheral direction CD, and a land portion which is sectioned by the main groove 5a. The tread portion 3 has a conductive rubber 52 which extends in a thickness direction of the cap rubber 50, passes an inner portion of the cap rubber 50 and gets to a bottom surface of the base rubber 51 from a ground surface E.

In the above, the ground surface is a surface which is grounded onto a road surface when the tire is vertically put on a flat road surface in a state in which the tire is assembled in a normal rim, and a normal internal pressure is filled, and a normal load is applied to the tire, and an outermost position in the tire width direction WD comes to a ground end E. The normal load and the normal internal pressure indicate a maximum load (a design normal load in the case of a tire for a passenger car) which is defined in JISD4202 (specification of an automotive tire) and a corresponding pneumatic pressure, and the normal rim indicates a standard rim which is defined in JISD4202 in principle.

The present embodiment employs a side-on tread structure achieved by mounting the side wall rubbers 6 onto both side end portions of the tread rubber 5, however, can employ a tread-on side structure achieved by mounting both side end portions of the tread rubber onto outer ends in the tire radial direction RD of the side wall rubbers, without being limited to the side-on tread structure.

Here, the conductive rubber is exemplified by a rubber in which a volume resistivity indicates a value less than 10⁸ Q·cm, and is produced, for example, by blending a carbon black serving as a reinforcing agent in a raw material rubber at a high rate. The conductive rubber can be obtained by blending a known conductivity applying agent, for example, a carbon-based conductivity applying agent such as a carbon fiber or a graphite, and a metal-based conductivity applying agent such as a metal powder, a metal oxide, a metal flake or a metal fiber, in addition to the carbon black.

Further, the non-conductive rubber is exemplified by a rubber in which a volume resistivity indicates a value equal to or more than 10⁸ Q·cm, and is exemplified by a material obtained by blending a silica serving as a reinforcing agent in the raw material rubber at a high rate. The silica is blended, for example, at 30 to 100 weight part in relation to 100 weight part of the raw material rubber component. The silica preferably employs a wet silica, however, can use any silica which is generally used as the reinforcing agent, without limitation. The non-conductive rubber may be produced by blending a burned clay, a hard clay, or a calcium carbonate, in addition to the silica such as a precipitated silica or a silicic anhydride.

As the raw material rubber mentioned above, a natural rubber, a styrene butadiene rubber (SBR), a butadiene rubber (BR), an isoprene rubber (IR) and an isobutylene-isoprene rubber (IIR) can be listed up, and they are used respectively by itself or by mixing two or more kinds. A vulcanizing agent, a vulcanization accelerator, a plasticizer or an antioxidant is appropriately blended in the raw material rubber.

In the light of enhancing a durability and improving a conduction performance, the conductive rubber desirably has a composition that a nitrogen adsorption specific surface area: N₂SA (m²/g) X composition amount (mass %) of carbon black is equal to or more than 1900, preferably equal to or more than 2000, and a dibutyl phthalate oil absorption: DBP (ml/100 g)×composition amount (mass %) of carbon black is equal to or more than 1500, preferably equal to or more than 1700. N₂SA can be determined in conformity to ASTM D3037-89, and DBP can be determined in conformity to D2414-90.

FIG. 2 is a cross sectional view showing the conductive rubber 52 and a peripheral structure thereof. An interface end P1 which is in contact with the conductive rubber 52 in an interface between the cap rubber 50 and the base rubber 51 comes down to the inner side RD2 in the radial direction in comparison with the interface existing in the periphery of the interface end P1. In the example in FIG. 2, an interface between a position P2 which is away from the conductive rubber 52 in the tire width direction WD at a predetermined distanced L1, and the interface end P1 comes down to the inner side RD2 in the radial direction in comparison with the position P2 which is away from the conductive rubber 52 in the interface in the tire width direction WD at the predetermined distance L1. In FIG. 2, the predetermined distance L1 is 5.0 mm, and comes down little by little to the inner side RD2 in the radial direction from the position P2 toward the interface end P1. In FIG. 2, W<L1 is established, in which W is the width of the conductive rubber 52. A thickness G1 of the base rubber 51 at the position P2 is 1.5 mm. A thickness G2 of the base rubber 51 at the interface end P1 is 1.0 mm.

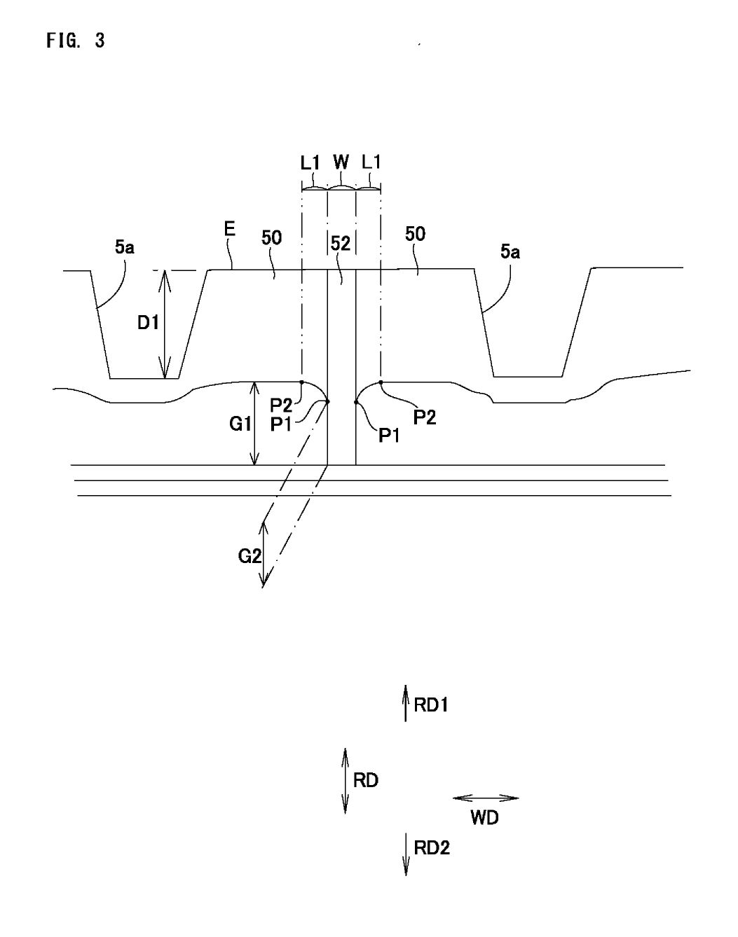

In an example in FIG. 3, the predetermined distance L1 is 1.5 mm. The thickness G1 of the base rubber 51 at the position P2 is 1.5 mm. The thickness G2 of the base rubber 51 at the interface end P1 is 1.0 mm. Here, the predetermined distance L1 is preferably equal to or more than the width W of the conductive rubber 52. If the relationship L1<W is established, the interface end P1 rapidly comes down to the inner side in the radial direction, and there is fear that the strain is concentrated. The maximum value of L1 is preferably set to a range which does not go beyond the main groove. As shown in FIGS. 2 and 3, a relationship 1.5 mm≤L1≤5.0 mm is preferable.

In the examples in FIGS. 2 and 3, the thickness of the other portions than the main groove of the cap rubber 50 is preferably equal to or more than (D1−1.6) mm. The depth of the main groove 5a is D1. The thickness of the lower portion of the main groove 5a of the cap rubber 50 is preferably equal to or more than 0.5 mm. The thickness of the base rubber 51 is preferably less than (D1−1.6) mm. If these conditions are satisfied, it is possible to prevent the base rubber 51 from being exposed to the tread surface even in the case that the tire wears.

### EXAMPLES

In order to specifically show the structure and the effect of the present disclosure, the following evaluations were carried out in relation to the following examples.

(1) Durability (Wear End Stage)

A tire having a size 195/65R15 was used, and was traveled on an asphalt or concrete road surface, and a distance until an interface separation was generated was measured. The result was expressed by an index number in which the result of Comparative Example 1 was 100. The longer the distance is (the greater the index number is), the more excellent the durability is. The test condition was set such that the pneumatic pressure was designated by the vehicle, and the load was a capacity vehicle on the assumption that one passenger was 55 kg. The wear end stage was set to a state in which the tire was worn until the groove depth comes to 0.5 mm from the tire wear indicator (TWI).

### Example 1

The embodiment shown in FIG. 2 was set to Example 1.

### Example 2

The embodiment shown in FIG. 3 was set to Example 2.

### Comparative Example 1

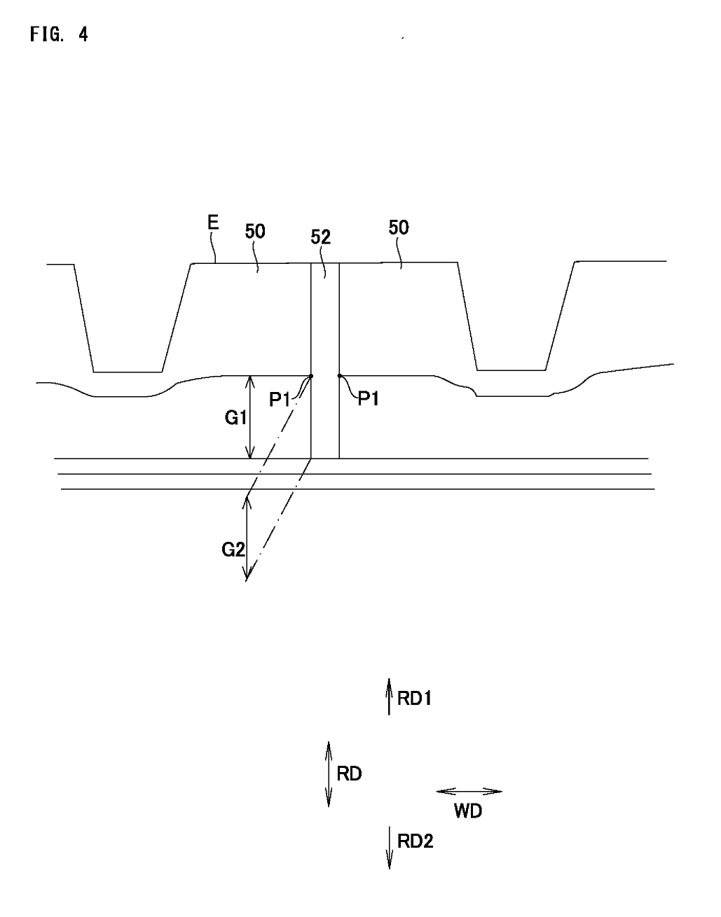

As shown in FIG. 4, the interface between the base rubber 51 and the cap rubber 50 extends horizontally in the periphery of the conductive rubber 52. Therefore, the thickness G2 of the base rubber 51 at the intermediate between the conductive rubber 52 and the main groove 5a is equal to the thickness G1 of the base rubber 51 at the interface end P1, and they are both 1.5 mm. The remaining factors are the same as those of Example 1.

### Comparative Example 2

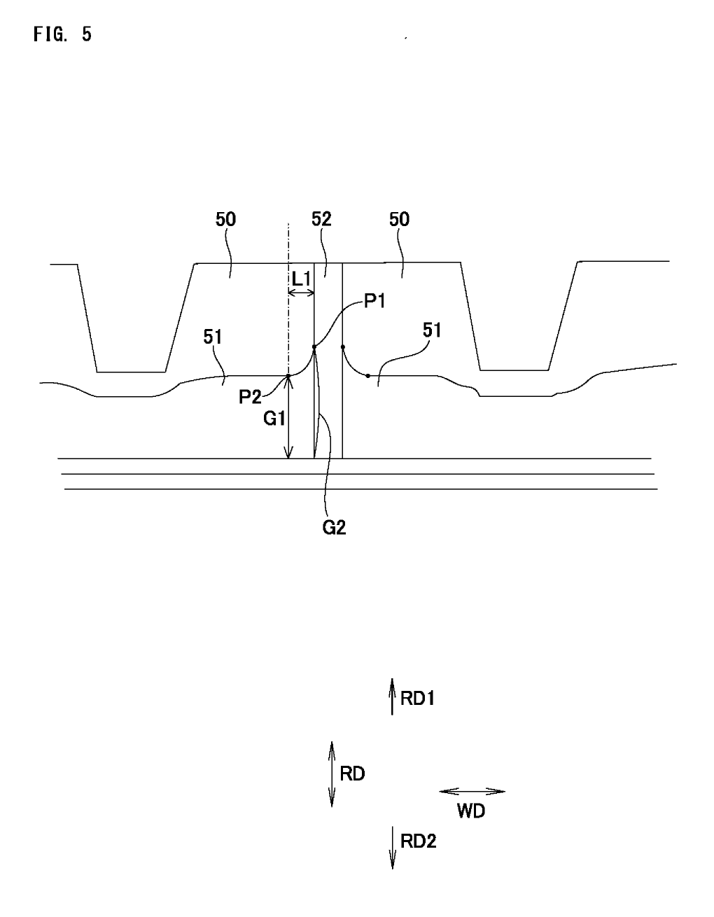

As shown in FIG. 5, the interface between the position P2 which is away from the conductive rubber 52 in the tire width direction WD at the predetermined distance L1, and the interface end P1 rises to the outer side RD1 in the radial direction in comparison with the position P2. The predetermined distance L1 is 1.5 mm, the thickness G1 of the base rubber 51 at the position P2 is 1.5 mm, and the thickness G2 of the base rubber 51 at the interface end P1 is 2.0 rm.

TABLE 1

| | Comparative | Comparative | | |
|---|---|---|---|---|
| | Example 1 | Example 2 | Example 1 | Example 2 |
| Structure | FIG. 4 | FIG. 5 | FIG. 2 | FIG. 3 |
| view | | | | |
| Thickness of | G1 = 1.5 mm | G1 = 1.5 mm | G1 = 1.5 mm | G1 = 1.5 mm |
| base rubber | G2 = 1.5 mm | G2 = 2.0 mm | G2 = 1.0 mm | G2 = 1.0 mm |
| Slope starting | No slope | 1.5 mm from | 5.0 mm from | 1.5 mm from |
| position of | | conductive | conductive | conductive |
| base rubber | | rubber | rubber | rubber |
| | | interface | interface | interface |
| Durability | 100 | 98 | 103 | 102 |
| (Wear end | | | | |
| stage) | | | | |

From Table 1. Comparative Example 2 is deteriorated more than Comparative Example 1. It can be thought that this is caused by the fact that the interface end P1 of the base rubber 51 rises to the outer side RD1 in the radial direction and the strain is concentrated on the end portion. Examples 1 and 2 are improved in the durability in comparison with Comparative Examples 1 and 2. It can be thought that this is caused by the fact that the interface end P1 of the base rubber 51 comes down to the inner side RD2 in the radial direction and the strain concentration can be avoided.

As mentioned above, the pneumatic tire according to the present embodiment has a cap rubber 50 which is formed by a nonconductive rubber and constructs a ground surface E, a base rubber 51 which is provided in an inner side RD2 in a tire radial direction of the cap rubber 50, and a conductive rubber 52 which extends in a thickness direction of the cap rubber 50, passes an inner portion of the cap rubber 50 and gets to a bottom surface of the base rubber 51 from the ground surface E. An interface end P1 which is in contact with the conductive rubber 52 in an interface between the cap rubber 50 and the base rubber 51 comes down to an inner side RD2 in a radial direction in comparison with an interface in a periphery of the interface end.

According to the structure, since the interface end P1 of the base rubber 51 comes down to the inner side RD2 in the radial direction, it is possible to avoid the strain concentration and it is possible to improve the durability.

According to the present embodiment, the interface between a position P2 which is away from the conductive rubber 52 in a tire width direction WD at a predetermined distance L1, and the interface end P1 comes down to the inner side RD2 in the radial direction in comparison with the position P2. The predetermined distance L1 is equal to or more than a width W of the conductive rubber 52.

According to the structure, since the interface end P1 is avoided to rapidly come down to the inner side in the radial direction, it is possible to prevent the durability from being deteriorated due to the strain concentration.

According to the present embodiment, the interface between a position P2 which is away from the conductive rubber 52 in a tire width direction WD at a predetermined distance L1, and the interface end P1 comes down to the inner side RD2 in the radial direction in comparison with the position P2. The predetermined distance L1 is equal to or less than 5.0 mm and equal to or more than 1.5 mm.

This structure is the preferable example.

It is possible to apply the structure employed in each of the embodiments to the other optional embodiment. The particular structure of each of the portions is not limited to the embodiments mentioned above, but can be variously modified within a range which does not deviate from the scope of the present invention.

What is claimed is:

1. A pneumatic tire comprising:
a cap rubber which is formed by a nonconductive rubber and constructs a ground surface;
a base rubber which is provided in an inner side in a tire radial direction of the cap rubber; and
a conductive rubber which extends in a thickness direction of the cap rubber, passes an inner portion of the cap rubber and gets to a bottom surface of the base rubber from the ground surface,
wherein an interface end which is in contact with the conductive rubber in an interface between the cap rubber and the base rubber comes down to an inner side in a radial direction in comparison with an interface in a periphery of the interface end.

2. The pneumatic tire according to claim 1, wherein the interface between a position which is away from the conductive rubber in a tire width direction at a predetermined distance, and the interface end comes down to the inner side in the radial direction in comparison with the position, and
wherein the predetermined distance is equal to or more than a width W of the conductive rubber.

3. The pneumatic tire according to claim 1, wherein the interface between a position which is away from the conductive rubber in a tire width direction at a predetermined distance, and the interface end comes down to the inner side in the radial direction in comparison with the position, and
wherein the predetermined distance is equal to or less than 5.0 mm and equal to or more than 1.5 mm.

4. The pneumatic tire according to claim 1, wherein the cap rubber has a main groove having a depth D1, and
wherein a thickness of the cap rubber except the main groove is equal to more than (D1−1.6) mm.

5. The pneumatic tire according to claim 4, wherein a thickness of the cap rubber in a lower portion of the main groove is equal to more than 0.5 mm.

6. The pneumatic tire according to claim 5, wherein a thickness of the base rubber is less than (D1−1.6) mm.
